(19) United States
(12) Patent Application Publication
(10) Pub. No.: US 2002/0005988 A1
(43) Pub. Date: Jan. 17, 2002

(54) Microetalon for DWDM telecommunications applications

(76) Inventors: Christopher J. Duska, Lexington, MA (US); Jose Downes, Belmont, MA (US); Reich Watterson, Lexington, MA (US); Kevin McCallion, Boston, MA (US)

Correspondence Address: Pandiscio & Pandiscio, 470 Totten Pond Road, Waltham, MA, 02451, US

(21) Appl. No.: 09/859,938

(22) Filed: May 17, 2001

Related U.S. Application Data
(60) Provisional application No. 60/204,967, filed on May 17, 2000.

(51) Int. Cl. G01J 3/45

(52) U.S. Cl. 359/577; 356/454

(57) ABSTRACT

An etalon comprising a first plate and a second plate positioned in parallel to one another and separated by a given distance, a single block spacer extending the given distance between the first plate and the second plate, and the single block spacer defining a chamber extending the given distance between the first plate and the second plate. A hermetically sealed etalon is also disclosed comprising a first plate and a second plate positioned in parallel to one another and separated by a given distance, a single block spacer extending the given distance between the first plate and the second plate, and the single block spacer defining a chamber extending the given distance between the first plate and the second plate, with the block spacer defining a first perimeter surrounding the chamber adjacent the first plate and a second perimeter surrounding the chamber adjacent the second plate, wherein the single block spacer surrounds the chamber along the given distance between the first plate and the second plate, and further wherein the single block spacer forms a first seal around the first perimeter adjacent the first plate and the single block spacer forms a second seal around the second perimeter adjacent the second plate, whereby to form the hermetically sealed etalon.

REFERENCE TO PENDING PRIOR PATENT APPLICATION

This patent application claims benefit of pending prior U.S. Provisional Patent Application Serial No. 60/204,967, filed May 17, 2000 by Chris Duska et al. for MICROETALON FOR DWDM TELECOMMUNICATIONS APPLICATIONS (Attorney's Docket No. CORE-64 PROV), which patent application is hereby incorporated herein by reference.

### FIELD OF THE INVENTION

This invention relates to etalon telecommunication apparatus and methods in general, and more particularly to apparatus and methods using etalons of a reduced size.

### BACKGROUND OF THE INVENTION

A traditional etalon consists of two parallel plates separated by an air gap. Typically the air gap is formed by positioning one or two block spacers on opposite ends of the plates. Optical contact may hold the plates to the spacers. This optical contact may be van der Waals forces established between the opposing highly polished surfaces of the block spacers and the plates.

These air gap etalons are also used by forming the spacers out of non-heat-sensitive materials and hermetically sealing the etalon in a closed package, such that changes of temperature do not affect the performance of the etalon.

For some applications, however, the etalons need to be very small, and it is difficult to create the etalons using the traditional construction technique. Among other things, as the size of the components is reduced, the surface area contact between the plates and the block spacers is also reduced. As such, it is no longer possible to hold the block spacers and parallel plates together by the traditional optical contact.

Additionally, alignment can be important in many etalon applications, since the angle of incidence of the input light beam can affect the output characteristics of the etalon. As a result, alignment must be provided in many applications. In some circumstances, it can be convenient to align the etalon before it is hermetically sealed in a closed package.

However, the performance characteristics of the air gap etalon can change if there is a variation in the etalon's air environment between the time of alignment and the time of hermetic sealing. Therefore, it would be an advance in the art to provide an improved etalon having reduced size and/or a hermetically sealed air gap.

### SUMMARY OF THE INVENTION

Accordingly, one object of the invention is to provide an improved etalon having a reduced size.

Another object of the invention is to provide an etalon with a hermetically sealed chamber.

A further object of the invention is to provide an etalon with a single block spacer defining a cavity.

A still further object of the invention is to provide a method for filtering a light source using an etalon having a reduced size.

And still another object of the invention is to provide a method for filtering a light source using an etalon having a hermetically sealed chamber.

With the above and other objects in view, as will hereinafter appear, there is provided an etalon comprising a first plate and a second plate positioned in parallel to one another and separated by a given distance; a single block spacer extending the given distance between the first plate and the second plate; and the single block spacer defining a chamber extending the given distance between the first plate and the second plate.

In accordance with a further feature of the invention, there is provided a hermetically sealed etalon comprising a first plate and a second plate positioned in parallel to one another and separated by a given distance; a single block spacer extending the given distance between the first plate and the second plate; and the single block spacer defining a chamber extending the given distance between the first plate and the second plate, the block spacer defining a first perimeter surrounding the chamber adjacent the first plate and a second perimeter surrounding the chamber adjacent the second plate, wherein the single block spacer surrounds the chamber along the given distance between the first plate and the second plate, and further wherein the single block spacer forms a first seal around the first perimeter adjacent the first plate and the single block spacer forms a second seal around the second perimeter adjacent the second plate, whereby to form the hermetically sealed etalon.

In accordance with a still further feature of the invention, there is provided an etalon assembly comprising a light source producing a collimated beam of light; an etalon receiving the collimated beam of light and producing a light emission, the etalon comprising a first plate and a second plate positioned in parallel to one another and separated by a given distance, a single block spacer extending the given distance between the first plate and the second plate, and the single block spacer defining a chamber extending between the first plate and the second plate; and a detector for receiving the light emission from the etalon.

In accordance with a further feature of the invention, there is provided a method for filtering a light source using an etalon, the method comprising: producing a collimated beam of light with the light source; receiving the collimated beam of light into the etalon, the etalon comprising a first plate and a second plate positioned in parallel to one another and separated by a given distance, a single block spacer extending the given distance between the first plate and the second plate, and the single block spacer defining a chamber extending between the first plate and the second plate; and producing a light emission from the etalon.

The above and other features of the invention, including various novel details of construction and combinations of parts and method steps, will now be more particularly described with reference to the accompanying drawings and pointed out in the claims. It will be understood that the particular devices and method steps embodying the invention are shown by way of illustration only and not as limitations of the invention. The principles and features of this invention may be employed in various and numerous embodiments without departing from the scope of the invention.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic perspective view of one form of a hermetically sealed etalon with a single block spacer, illustrative of an embodiment of the invention;

FIG. 2 is a schematic perspective view of an alternative embodiment of the invention showing an etalon with a single block spacer open at the top portion of the cavity;

FIG. 3 is a schematic perspective view of an alternative embodiment of the invention showing an etalon having two spacers forming a hermetic seal; and

FIG. 4 is a schematic view of an etalon assembly formed in accordance with the present invention.

### DETAILED DESCRIPTION OF THE PREFERRED EMBODIMENTS

The present invention is an etalon for DWDM telecommunications applications. The present invention may be constructed so as to permit a reduced size of etalon. The present invention may also be constructed such that the etalon is hermetically sealed.

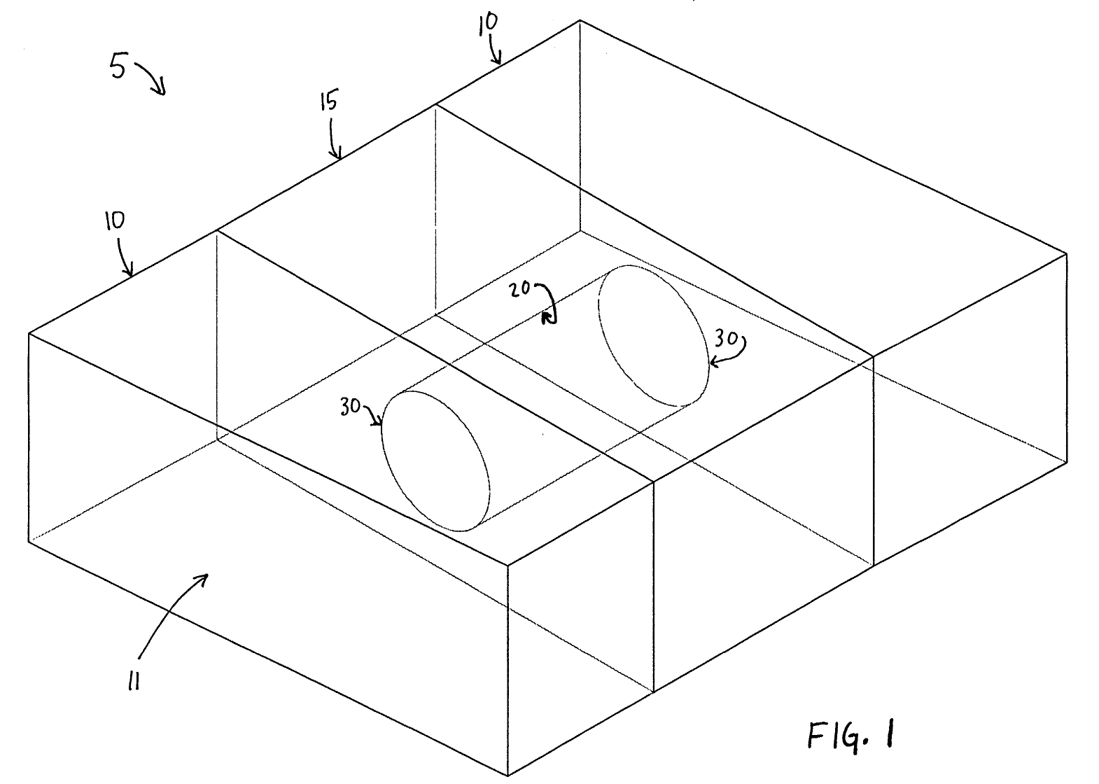

Referring to FIG. 1, an etalon 5 is shown having two parallel plates 10 separated by a spacer 15. Spacer 15 is formed with a chamber 20 extending therethrough, between parallel plates 10. Spacer 15 and chamber 20 are dimensioned so as to provide an optimal surface area contact between spacer 15 and plates 10.

In one preferred embodiment of the present invention, optical contact holds plates 10 to spacer 15. Optical contact includes van der Waals forces between opposing highly polished surfaces of plates 10 and spacer 15.

In a preferred embodiment of the present invention, chamber 20 is sealed around its perimeter with each parallel plate 10. This sealing forms a hermetically sealed chamber 20 and hence a hermetically sealed etalon 5.

More particularly, and still referring now to FIG. 1, a hermetically sealed etalon 5 is shown with single block spacer 15 completely surrounding chamber 20 along the distance between plates 10. Single block spacer 15 forms a seal around each perimeter 30 of chamber 20, i.e., adjacent the contact area between plates 10 and spacer 15. These sealed perimeters 30 form a hermetically sealed chamber 20 and, therefore, form a hermetically sealed etalon 5.

In one preferred form of the invention, plates 10 comprise fused silica and preferably have a reflective coating in their inside surfaces, i.e., the surfaces facing chamber 20A. Preferably both of the plates 10 has a non-parallel or non-reflective outer surface, e.g., a non-parallel outer surface 11.

And in one preferred form of the invention, single block spacer 15 comprises a glass having a low thermal expansion. By way of example but not limitation, spacer 15 may be formed out of ULE or ZERODUR.

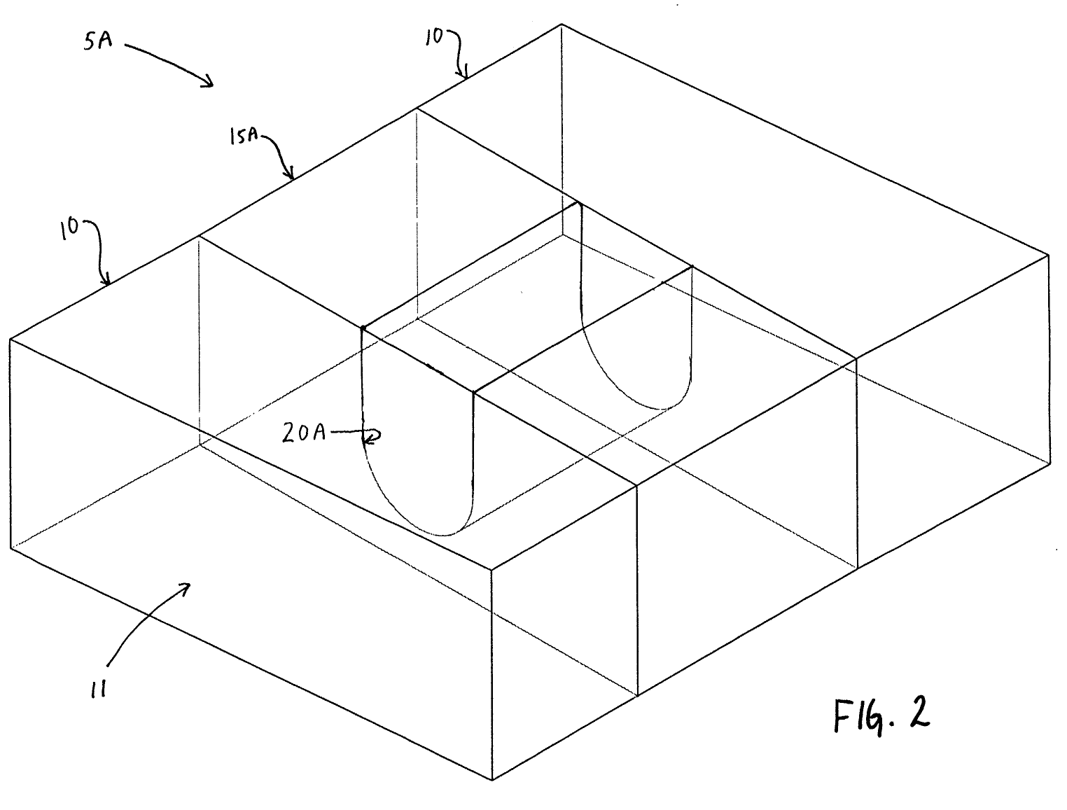

Looking next at FIG. 2, an etalon 5A is shown with a single block spacer 15A having an open chamber 20A. Single block spacer 15A is formed so as to provide an enhanced surface area contact between spacer 15A and plates 10. In this embodiment of the invention, however, chamber 20A is not hermetically sealed within etalon 5.

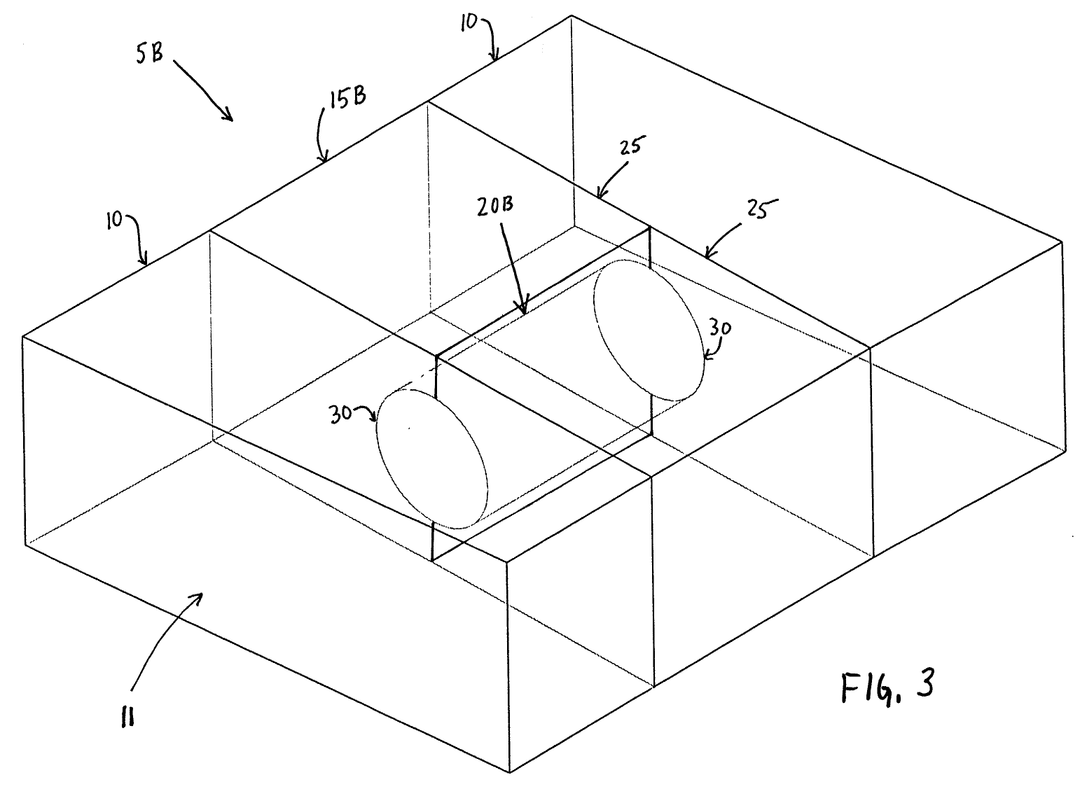

Referring now to FIG. 3, an etalon 5B is shown with two portions 25 forming spacer 15B. The two spacer portions 25 surround chamber 20B along the entire distance between plates 10. In addition, a seal is formed around each perimeter 30 adjacent to the contact area between plates 10 and spacer 15B. These sealed perimeters 30 form a hermetically sealed chamber 20 and, therefore, form a hermetically sealed etalon 5.

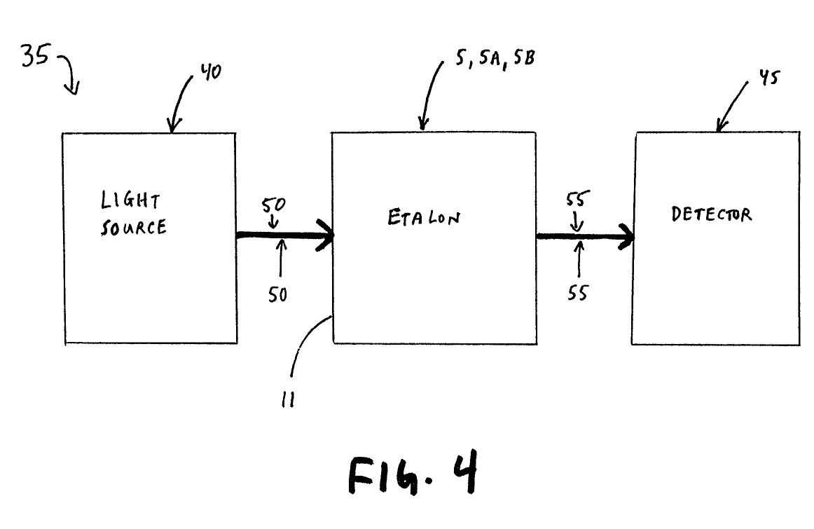

In a preferred embodiment of the invention, and referring now to FIG. 4, etalon 5 (or 5A or 5B) may be used in conjunction with an etalon assembly 35. Etalon assembly 35 includes a light source 40, etalon 5 (or 5A or 5B), and a detector 45. Light source 40 produces a collimated light beam 50. Etalon 5 (or 5A or 5B) receives the collimated light beam 50 and produces a light emission 55. Detector 45 receives emission 55 from etalon 5 (or 5A or 5B).

A method also is disclosed for filtering light source 40 using etalon 5 (or 5A or 5B). The method includes producing a collimated light beam 50 with light source 40, passing the collimated light beam 50 into etalon 5 (or 5A or 5B), and producing a light emission 55 from etalon 5 (or 5A or 5B).

What is claimed is:

1. An etalon comprising:
a first plate and a second plate positioned in parallel to one another and separated by a given distance;
a single block spacer extending said given distance between said first plate and said second plate; and
said single block spacer defining a chamber extending said given distance between said first plate and said second plate.

2. The etalon of claim 1 wherein said single block spacer substantially surrounds said chamber along the entire length between said first plate and said second plate.

3. The apparatus of claim 1 wherein said chamber contains a fluid.

4. The apparatus of claim 3 wherein said fluid is a gas.

5. The apparatus of claim 4 wherein said gas is air.

6. The apparatus of claim 2 wherein said chamber forms a vacuum.

7. The apparatus of claim 1 wherein said single block spacer is optically contacted with said first plate and said second plate, respectively.

8. The apparatus of claim 7 wherein van der Waals forces hold said single block spacer optically contacted with said first plate and said second plate, respectively.

9. The apparatus of claim 1 wherein said first plate and said second plate each include a reflective coating on an inner surface in opposition to one another.

10. The apparatus of claim 1 wherein at least one of said first plate and said second plate includes a non-parallel outer surface.

11. The apparatus of claim 1 wherein said chamber of said single block spacer is a cylindrical shape.

12. The apparatus of claim 1 wherein said single block spacer is composed of a glass.

13. The apparatus of claim 12 wherein said glass has a low thermal expansion.

14. The apparatus of claim 13 wherein said glass is one of a group consisting of ULE and ZERODUR.

15. The apparatus of claim 1 wherein said given distance of said single block spacer is determined by a desired free spectral range of said etalon.

16. The apparatus of claim 1 wherein said first plate and said second plate each have an inner surface facing one another, and each of said inner surfaces is polished flat for optical contact with said single block spacer.

17. The apparatus of claim 1 wherein said first plate and said second plate are fused silica.

18. A hermetically sealed etalon comprising:
a first plate and a second plate positioned in parallel to one another and separated by a given distance;
a single block spacer extending said given distance between said first plate and said second plate; and
said single block spacer defining a chamber extending said given distance between said first plate and said second plate, said block spacer defining a first perimeter surrounding said chamber adjacent said first plate and a second perimeter surrounding said chamber adjacent said second plate, wherein said single block spacer surrounds said chamber along said given distance between said first plate and said second plate, and further wherein said single block spacer forms a first seal around said first perimeter adjacent said first plate and said single block spacer forms a second seal around said second perimeter adjacent said second plate, whereby to form said hermetically sealed etalon.

19. An etalon assembly comprising:
a light source producing a collimated beam of light;
an etalon receiving said collimated beam of light and producing a light emission, said etalon comprising:
a first plate and a second plate positioned in parallel to one another and separated by a given distance;
a single block spacer extending said given distance between said first plate and said second plate; and
said single block spacer defining a chamber extending between said first plate and said second plate; and
a detector for receiving said light emission from said etalon.

20. A method for filtering a light source using an etalon, said method comprising:
producing a collimated beam of light with said light source;
receiving said collimated beam of light into said etalon, said etalon comprising:
a first plate and a second plate positioned in parallel to one another and separated by a given distance;
a single block spacer extending said given distance between said first plate and said second plate; and
said single block spacer defining a chamber extending between said first plate and said second plate; and
producing a light emission from said etalon.

21. A hermetically sealed etalon comprising:
a first plate and a second plate positioned in parallel to one another and separated by a given distance;
a first block spacer and a second block spacer extending said given distance between said first plate and said second plate; and
said first block spacer and said second block spacer defining a chamber extending said given distance between said first plate and said second plate, said first block spacer and said second block spacer together defining a first perimeter surrounding said chamber adjacent said first plate and a second perimeter surrounding said chamber adjacent said second plate, wherein said first block spacer and said second block spacer together surround said chamber along said given distance between said first plate and said second plate, and further wherein said first block spacer and said second block spacer together form a first seal around said first perimeter adjacent said first plate and a second seal around said second perimeter adjacent said second plate, whereby to form said hermetically sealed etalon.
